(19) United States
(12) Patent Application Publication
(10) Pub. No.: US 2022/0296016 A1
(43) Pub. Date: Sep. 22, 2022

(54) CERAMIC HOUSEWARE SET WITH INTERCHANGEABLE DECORATIVE ELEMENTS

(71) Applicants: Robin Ann Schaffer, Fort Wayne, IN (US); Reginald Wayne Tomblin, Rockwall, TX (US)

(72) Inventors: Robin Ann Schaffer, Fort Wayne, IN (US); Reginald Wayne Tomblin, Rockwall, TX (US)

(21) Appl. No.: 17/249,843

(22) Filed: Mar. 16, 2021

(51) Int. Cl. A47G 19/30; G09F 7/04

(52) U.S. Cl. CPC A47G 19/30; G09F 7/04

(57) ABSTRACT

A ceramic houseware set including a plurality of interchangeable decorative elements is disclosed. The set includes a ceramic main body that has an outer side and defines a main body recess on the outer side thereof. The main body recess receives either a magnet or a ferromagnetic material. The decorative elements each include, on a back side thereof, a complementary ferromagnetic material or magnet for coupling to the magnet or ferromagnetic material on the main body. In use, the decorative elements selectively couple to the main body such that they are interchangeable.

### BACKGROUND OF THE INVENTION

The present invention relates to ceramic housewares and, more particularly, to ceramic housewares with ferromagnetic or magnetic material embedded to apply various decorative elements in order to change the appearance of the housewares.

Currently, ceramic housewares (e.g., vases, jars, soap containers, butter dishes, air fresheners, serving plate stands, paper towel holders, pitchers, etc.) are often provided with decorative elements and, in many cases, the decorative elements are seasonal in nature. For example, a snowflake might be used for winter use housewares, while a pumpkin might be used for fall use housewares or a heart might be used for Valentine's Day, etc. These decorative elements are typically permanently affixed to the ceramic material using various means, such as adhesives.

Consequently, the only presently available option for the housewares' owner to change up the style of the ceramic housewares is to buy new ones. Clearly, there are many downsides to needing to buy new ceramic housewares every time the season changes, every time there is a new holiday to decorate for, or when the owner's style changes. Buying new housewares to provide for a new decorative element can be expensive and is also inconvenient for the housewares' owner, because all the housewares not in use still need to be stored somewhere.

As can be seen, there is a need for an improved ceramic houseware and method for providing the houseware that allows an owner easy customization of the ceramic houseware.

### SUMMARY OF THE INVENTION

In one aspect of the present invention, a ceramic houseware comprises: a main body including an outer side and defining a main body recess on the outer side, the main body recess receiving one of a magnet and a ferromagnetic material; and a first decorative element including, on a back side thereof, the other of the magnet and the ferromagnetic material, the first decorative element and the main body being configured to selectively couple to one another via the magnet and the ferromagnetic material.

In another aspect of the present invention, a ceramic houseware comprises: a main body including an outer side and defining a main body recess on the outer side, the main body recess receiving one of a first coupling member and a second coupling member; and a first decorative element defining a decorative element recess on a back side thereof, the decorative element recess receiving the other of the first coupling member and the second coupling member, the first decorative element and the main body being configured to selectively couple to one another via the first coupling member and the second coupling member.

In yet another aspect of the present invention, a ceramic houseware set comprises: a main body including an outer side and defining a main body recess on the outer side, the main body recess receiving one of a magnet and a ferromagnetic material; a first decorative element including, on a back side thereof, the other of the magnet and the ferromagnetic material, the first decorative element and the main body being configured to selectively couple to one another via the magnet and the ferromagnetic material; and a second decorative element including, on a back side thereof, the other of the magnet and the ferromagnetic material, the second decorative element and the main body being configured to selectively couple to one another via the magnet and the ferromagnetic material.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of the embodiment of the present invention, showing metal pieces;

FIG. 3 is a cross-sectional view of the embodiment of the present invention, taken along line 3-3 in FIG. 1;

FIG. 4 is an exploded view of the embodiment of the present invention, showing different decorative pieces; and

FIG. 5 is a perspective view of an alternative embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, one embodiment of the present invention is a ceramic houseware set including a plurality of interchangeable decorative elements is disclosed. The set includes a ceramic main body (e.g. vase, jar, soap container, butter dish, air freshener, serving plate stand, paper towel holder, pitcher, etc.) that has an outer side and defines a main body recess on the outer side thereof. The main body recess receives either a magnet or a ferromagnetic material. The decorative elements each include, on a back side thereof, a complementary ferromagnetic material or magnet for coupling to the magnet or ferromagnetic material on the main body. In use, the decorative elements selectively couple to the main body such that they are interchangeable. Thus, a user of embodiments of the present invention is afforded limitless re-configurations of a single ceramic houseware.

Advantageously, the present invention provides a way for interchangeably connecting decorative elements to various ceramic housewares. In the present embodiment described, this is achieved by providing a ferromagnetic material in either the decorative elements or the ceramic houseware and a magnetic material in the other. In certain embodiments, the ferromagnetic and magnetic materials are embedded within the respective decorative elements and ceramic housewares to provide a flush joint between the parts (i.e., the parts directly abut one another). By doing so, the present invention allows for consumers to easily change the overall look of the ceramic houseware or household product in just a few seconds. Because the decorative elements themselves are typically small in size, they can easily be stored for use later. It will be appreciated that while the term “houseware” generally refers to decorative (and sometimes functional) objects that are typically used in a house, a person with skill in the art would appreciate that the housewares described herein are usable in any number of places, including commercial settings.

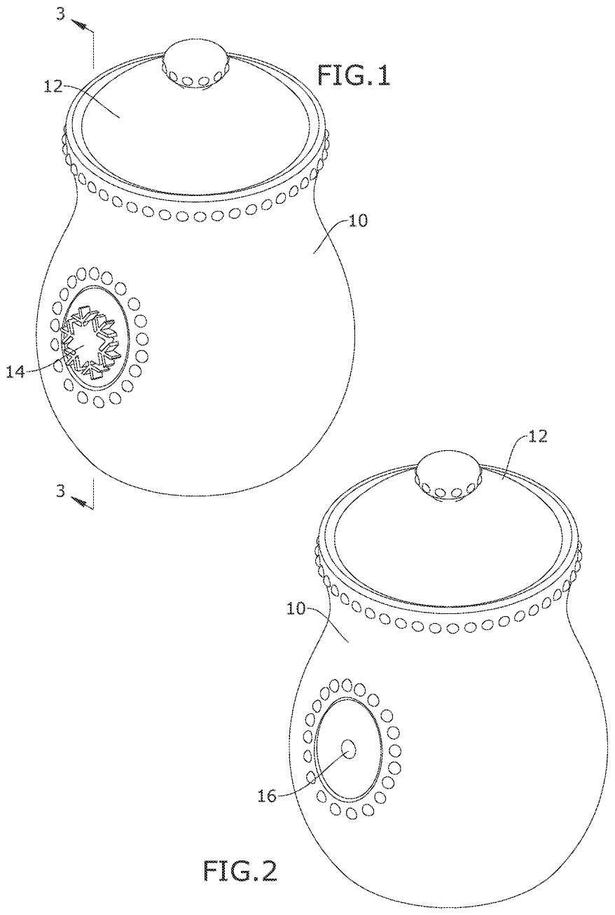

Referring to FIGS. 1-5, a ceramic houseware (illustrated as a jar in the presently described embodiment) may include a main body 10 and a lid 12. A decorative element 14 is removably couplable to the main body 10. The removable coupling may be achieved, in certain embodiments, by a ferromagnetic disc 16 embedded in the main body 10 via a main body recess 15 and a magnet 18 embedded in the decorative element 14 via a decorative element recess 17, with the ferromagnetic disc 16 and magnet 18 functioning as coupling members in the present invention. The magnet 18 and ferromagnetic disc 16 may be secured in the recesses 15, 17 using, for example, an adhesive material. Of course, the size and shape of the ferromagnetic disc 16 and magnet 18 may be modified, as appropriate, in accordance with the present invention. Further, in certain embodiments, the magnet 18 may be embedded in the main body 10 and the ferromagnetic disc 16 may be embedded in the decorative element 14. In even further embodiments, the decorative element 14 may be provided as a ferromagnetic material such that a separate ferromagnetic disc would not be required to facilitate the coupling.

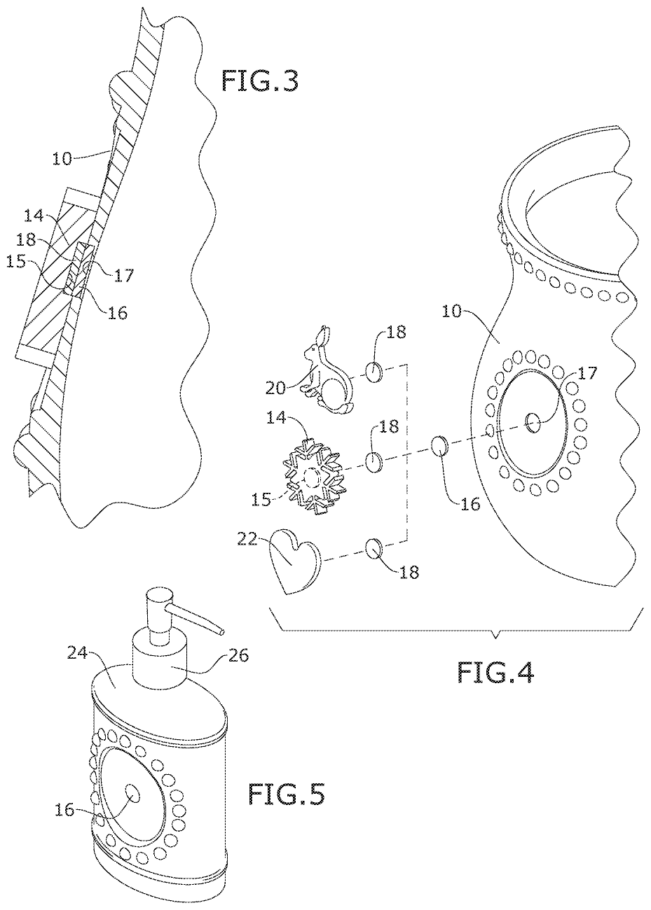

As seen in FIG. 3, the depths of the main body recess 17 and the decorative element recess 15, as well as the ferromagnetic disc 16 and magnet 18, are sized such that the decorative element 14 may lay flush against a surface of the main body. This provides a clean final appearance, such that it cannot be discerned that the decorative element 14 is a removable piece of the ceramic houseware. In certain embodiments, the ferromagnetic disc 16 and magnet 18 lay substantially flush with the ends of the respective recesses 15, 17. In other embodiments, and as shown in FIG. 3, either one of the ferromagnetic disc 16 and the magnet 18 may project slightly out of the corresponding recess (such as the main body recess 17, as shown) and into the opposing recess (such as the decorative element recess, as shown) when the ferromagnetic disc 16 and magnet attract and contact one another. By doing so, a more stable connection may be achieved because the decorative element 14 will be prevented from sliding downwards due to gravity.

As shown in use, and referring to FIG. 4, other decorative elements (in combination with the ceramic houseware forming a set), such as a second decorative element 20 (embodied as a rabbit) and a third decorative element 22 (embodied as a heart) may be interchangeably used with the ceramic houseware 10 to create any number of different overall aesthetics. To do so, a user would simply remove the current decorative element 14 (embodied as a snowflake), select a desired alternative decorative element 20, 22, and position it in place on the main body 10. The magnetic attraction of the ferromagnetic disc 16 and magnet 18 pulls and retains the selected decorative element 14, 20, 22 to the main body 10. This process can be repeated any number of times based on the various desired looks of the user.

Further, as shown in FIG. 5, the ceramic houseware may be embodied a soap dispenser including a ceramic bottle 24 and a metal soap pump 26, with the bottle 24 having a ferromagnetic disc 16 disposed in a recess as previously described. As mentioned, the shape and function of the ceramic houseware may vary in accordance with the present invention. For example, the housewares may be embodied as various home use and décor items, including but not limited to: beverage pitchers, soap dispensers, paper towel holders, canisters, napkin holders, and more.

To make various embodiments of the present invention, a mold for making the ceramic houseware should be designed specifically that an indentation/recess 17 is formed in an outside wall of the main body 10. Then, a ferromagnetic material 16 or magnet 18 may be adhered within the recess 17, which creates a landing spot for the decorative element 14. The decorative elements 14, 20, 22 may be made using any appropriate process, with a recess 15 being formed on a back side of each decorative element 14, 20, 22 and a complementary ferromagnetic material 16 or magnet 18 is secured to each decorative element 14, 20, 22.

It should be understood, of course, that the foregoing relates to exemplary embodiments of the invention and that modifications may be made without departing from the spirit and scope of the invention as set forth in the following claims. In the following claims, any labelling of elements, limitations, steps, or other parts of a claim (for example, first, second, etc., (a), (b), (c), etc., or (i), (ii), (iii), etc.) is only for purposes of clarity, and are not to be interpreted as suggesting any sort of ordering or precedence of the claim parts so labelled. If any such ordering or precedence is intended, it will be explicitly recited in the claim or, in some instances, it will be implicit or inherent based on the specific content of the claim. To further aid the USPTO and any readers of any patent issued on this application, it is additionally noted that there is no intent any of the appended claims to invoke paragraph (f) of 35 U.S.C. § 112 as it exists on the date of filing hereof unless the words “means for” or “step for” are explicitly used in the particular claim.

What is claimed is:

1. A ceramic houseware comprising:
a main body including an outer side and defining a main body recess on the outer side, the main body recess receiving one of a magnet and a ferromagnetic material; and
a first decorative element including, on a back side thereof, the other of the magnet and the ferromagnetic material, the first decorative element and the main body being configured to selectively couple to one another via the magnet and the ferromagnetic material.

2. The ceramic houseware of claim 1, wherein the first decorative element further defines a decorative element recess on the backside thereof for receiving the other of the magnet and the ferromagnetic material.

3. The ceramic houseware of claim 2, wherein the ferromagnetic material is received in the main body recess and the magnet is received in the decorative element recess.

4. The ceramic houseware of claim 3, wherein the ferromagnetic material partially protrudes from the main body recess and is configured to partially extend into the decorative element recess when the first decorative element is coupled to the main body.

5. The ceramic houseware of claim 4, wherein the back side the first decorative element lays substantially flush against the outer side of the main body when the first decorative element is coupled with the main body.

6. The ceramic houseware of claim 1, wherein the magnet is received in the main body recess.

7. The ceramic houseware of claim 1, wherein a second decorative element is configured to selectively couple with the main body, with the second decorative element including, on a back side thereof, the other of the magnet and the ferromagnetic material.

8. The ceramic houseware of claim 1, wherein the back side the first decorative element lays substantially flush against the outer side of the main body when the first decorative element is coupled with the main body.

9. A ceramic houseware comprising:
a main body including an outer side and defining a main body recess on the outer side, the main body recess receiving one of a first coupling member and a second coupling member; and
a first decorative element defining a decorative element recess on a back side thereof, the decorative element recess receiving the other of the first coupling member and the second coupling member, the first decorative element and the main body being configured to selectively couple to one another via the first coupling member and second coupling member.

10. A ceramic houseware set comprising:
a main body including an outer side and defining a main body recess on the outer side, the main body recess receiving one of a magnet and a ferromagnetic material;
a first decorative element including, on a back side thereof, the other of the magnet and the ferromagnetic material, the first decorative element and the main body being configured to selectively couple to one another via the magnet and the ferromagnetic material; and
a second decorative element including, on a back side thereof, the other of the magnet and the ferromagnetic material, the second decorative element and the main body being configured to selectively couple to one another via the magnet and the ferromagnetic material.
